(19) United States
(12) Patent Application Publication
(10) Pub. No.: US 2010/0020972 A1
(43) Pub. Date: Jan. 28, 2010

(54) Wireless mobile device that permits toggling of whether to transmit information contained in SMS messages as encrypted or clear text

(76) Inventors: Ernest Samuel Baugher, Buda, TX (US); Venkata Chalapathi Majeti, Naperville, IL (US); Suresh Neelagaru, Amarillo, TX (US)

Correspondence Address: Carmen Patti Law Group , LLC, ONE N. LASALLE STREET, 44TH FLOOR, CHICAGO, IL, 60602, US

(21) Appl. No.: 12/317,186

(22) Filed: Dec. 19, 2008

Related U.S. Application Data
(63) Continuation-in-part of application No. 12/220,135, filed on Jul. 22, 2008.

(51) Int. Cl. H04K 1/00

(52) U.S. Cl. 380/255

(57) ABSTRACT

An exemplary method is implemented by a wireless mobile device that transmits and receives short message system (SMS) text messages. Entered first text to be transmitted as a first SMS text message from the wireless mobile device is accepted and stored by a resident application. A user selectable input is received by the resident application of the wireless mobile device, where the user selectable input controls whether a resident encryption algorithm will be used to convert the first text into an encrypted first text message. A user control input is received by the resident application that causes the transmission of the first SMS text message from the wireless mobile device. The text of the transmitted first SMS text message contains the first text if the resident encryption algorithm is not selected by the user. The text of the transmitted first SMS text message contains encrypted first text if the resident encryption algorithm is selected by the user.

### CROSS REFERENCE TO RELATED APPLICATIONS

This is a continuation-in-part application that claims the benefit of the prior filed U.S. patent application Ser. No. 12/220,135 filed Jul. 22, 2008 entitled “Wireless Mobile Device with User Selectable Privacy for Groups of Resident Application Programs and Files”.

### BACKGROUND

This invention relates to mobile communication devices capable of receiving and transmitting short message service (SMS) messages. It is more specifically directed to providing the ability to the user to toggle whether a message will be transmitted as a clear text message or as encrypted at any time during the drafting of the message. It is especially, but not exclusively, suited to providing the user with a mobile device with a single click toggle that determines whether a text or other message being or having been composed for transmission will be transmitted as a clear text message or an encrypted message.

Cellular telephones that are multimedia message service (MMS) and/or SMS capable can run a variety of resident application programs beyond basic voice communications. Functions such as address books, contact lists, internet browser, and text messaging applications are each typically represented by icons displayed on the screen of the cellular telephone or personal digital assistant. To access a particular function, the user can highlight or point and click on an icon displayed on the screen associated with the function/application desired to be accessed.

A typical SMS text messaging application available on a wireless mobile device supports a plurality of functions such as inbox, outbox (and/or sent), and compose (draft) of new messages. The compose function provides the user with a window that includes an addressee field and a text messaging area in which the characters and/or words to be transmitted are entered by the user. After the user has completed the composition of the text message to be transmitted, the user can transmit the message such as by selecting or clicking on a provided “send” or “transmit” button/icon. This causes the mobile device to generate an SMS packet that includes the addressee as the final destination as well as the text message represented by corresponding ASCII coded characters. After being routed through the telecommunication infrastructure network, this packet is delivered to the addressee's communication device with a notification to the addressee of the arrival of a text message. The addressee may elect to read the received message such as by opening the message that now appears in the addressee's inbox.

If a user desires to transmit a secured (encrypted) message intended to be only understood by the addressee, the user may employ a separate specialized encryption program such as resident on a separate standalone personal computer. The user may open the encryption program on the PC and enter the text to be delivered to the addressee. The encryption program will use an encryption key and encryption algorithm to convert the entered text into encrypted characters or digital representations that forms the encrypted message to be transmitted. After having completed this process, the user may store the encrypted text in a file of the PC and then transfer the encrypted message into a normal text messaging area of the compose function of an SMS mobile device and insert the address of the desired addressee. As long as the mobile device's compose function is provided with characters that can be transmitted utilizing the known SMS signaling format, transmission of the encrypted message will be handled like any other SMS message by the telecommunication infrastructure. In order to understand the received encrypted message, the addressee will transfer the body of the message to a separate standalone PC with the same specialized encryption program which will transform the encrypted message into understandable clear text assuming the addressee's encryption program uses the correct key required for successful decryption. Although such a process for transmitting a secure message can be successfully utilized, it is cumbersome for users. This process also lacks flexibility, e.g. if the user loads an encrypted message into the compose function of the mobile device and then decides that the message should be sent as clear text, the encrypted message will have to be deleted and the clear text form of the message manually retyped or transferred from a stored file.

Similarly, the lack of flexibility and convenience to determine whether a message should be transmitted as clear text or encrypted is not remedied by merely installing an additional separate encryption application on a mobile device where such an encryption application always sends and receives encrypted messages. The user of a mobile device with such an additional separate encryption application would still have to choose between using it to send an encrypted message and the build-in SMS messaging application to send a clear text message. If the user changes his mind regarding encryption after composing part or all of a message in one of these applications, the user will have to go to the other application and retype, or store and transfer the message file to the other application.

### SUMMARY

One object of the present invention is to provide the user of an SMS mobile device user with a messaging function capability that supports the ability to toggle back-and-forth whether a message will be transmitted as a clear text message or as encrypted at any time during the composition of the message. Another object is to provide the user with a single click operation of the toggle function.

An exemplary method is implemented by a wireless mobile device that transmits and receives SMS text messages. Entered first text to be transmitted as a first SMS text message from the wireless mobile device is accepted and stored by a resident application. A user selectable input is received by the resident application of the wireless mobile device, where the user selectable input controls whether a resident encryption algorithm will be used to convert the first text into an encrypted first text message. A user control input is received by the resident application that causes the transmission of the first SMS text message from the wireless mobile device. The text of the transmitted first SMS text message contains the first text if the resident encryption algorithm is not selected by the user. The text of the transmitted first SMS text message contains encrypted first text if the resident encryption algorithm is selected by the user.

Another exemplary embodiment of the invention includes the wireless mobile device that substantially implements the above method.

A further exemplary embodiment of the invention includes an article with computer readable instructions that substantially implement the above method.

### DESCRIPTION OF THE DRAWINGS

Features of exemplary implementations of the invention will become apparent from the description, the claims, and the accompanying drawings in which:

FIG. 1 is a block diagram of an exemplary system suited for support of a mobile device that incorporates an embodiment of the present invention.

FIG. 2 is a block diagram of an exemplary wireless mobile device in accordance with an embodiment of the present invention.

FIG. 3 is a flow chart illustrating steps of an exemplary method of an initial registration and acquisition of a privacy interface program in accordance with an embodiment of the present invention.

FIG. 4 is a flow chart illustrating steps of an exemplary method of installation of a privacy interface program in accordance with an embodiment of the present invention.

FIG. 5 is an exemplary text message composition window associated with the encryption function displayed on the screen of the mobile device.

FIG. 6 is a flow diagram illustrating an exemplary installation of a secure module that supports encryption/decryption of text messages.

FIG. 7 is a flow diagram illustrating the transmission of text messages utilizing the secure text message composition window in accordance with an embodiment of the present invention.

FIG. 8 is a flow diagram illustrating the processing of a received text message in accordance with an exemplary embodiment of the present invention.

### DETAILED DESCRIPTION

One aspect of the present invention resides in the recognition of the difficulties associated with creating and processing of encrypted text messages to be transmitted via an SMS mobile device. Such difficulties include a user's inconvenience in not being able to easily elect whether a text message being composed is to be encrypted or not prior to transmission of the message. In accord with an embodiment of the present invention, an encryption capability is integrated for use with the text messaging function for an SMS mobile device. For example, a text message being composed for transmission can be elected by the user to the sent as a clear text (normal) transmission or as an encrypted text message at any time prior to the transmission of the message. In a preferred embodiment, a single click by the user on a displayed encryption selection icon serves to toggle back-and-forth whether the text message being or having been composed will, upon transmission, be sent as a clear text message or as an encrypted text message. Preferably the encryption selection icon and/or a portion of the composition window, e.g. the text body portion, has two different states of visual indicia which correspondingly reflect the current selected state of clear text transmission or encrypted text transmission.

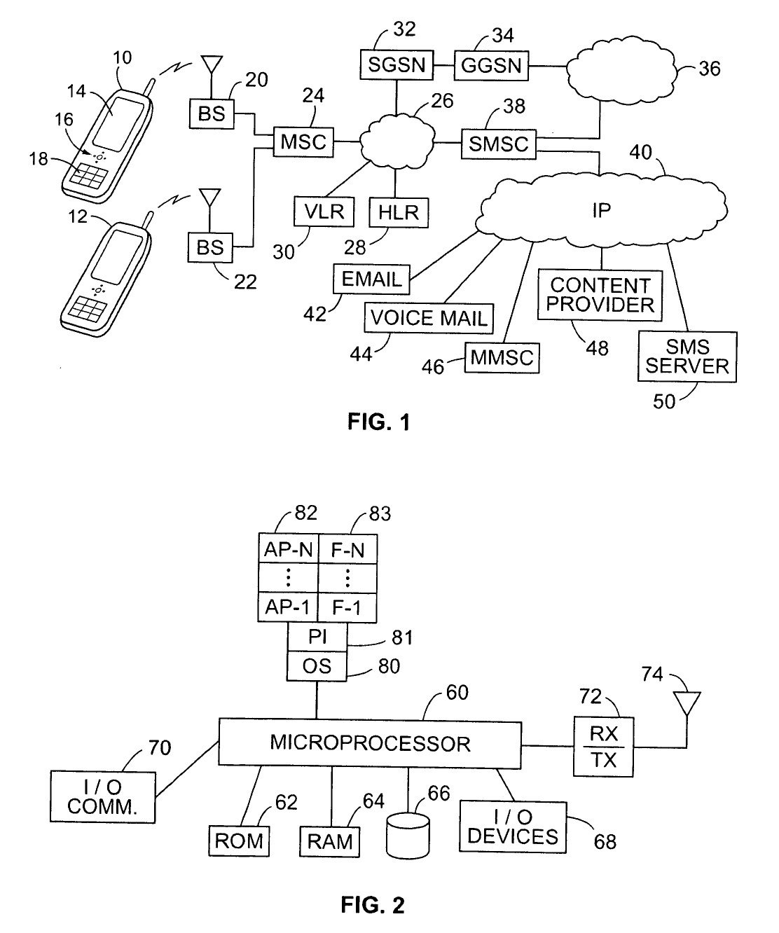

Referring to FIG. 1, an exemplary telecommunication network includes a system that supports wireless cellular subscribers with voice communications, multimedia message service (MMS) and/or SMS messaging. First and second subscribers utilize mobile devices 10 and 12 such as a cellular telephone with these capabilities. As used herein, a mobile device means a wireless portable SMS capable two-way communications apparatus intended to be held in one hand during normal operation, e.g. a cellular telephone or personal digital assistant (PDA), and does not include a laptop computer. Each exemplary mobile device includes a display screen 14, user input controls 16 associated with cursor and screen control, and a keypad and/or keyboard 18 for accepting additional user inputs.

The system includes base stations (BS) 20 and 22 that support wireless communications between the devices 10 and 12, respectively, as controlled by a mobile switching center (MSC) 24. Signaling and data information are carried to and from the MSC by a supporting communication system 26, e.g. signaling system 7 (SS7). Also coupled to the system 26 is a home location register (HLR) 28 and a visiting location register (VLR) 30 which facilitate registration, authentication and location information related to the mobile devices.

In this illustrative example, communications are provided by a general public radio service (GPRS). Accordingly, communications with a serving GPRS service node (SGSN) 32 is also supported by system 26. Communications between the SGSN 32 and other networks 36, e.g. public switched telephone network (PSTN), general services mobile (GSM) network or code division multiple access (CDMA) network, is facilitated by a gateway GPRS service node (GGSN) 34.

A SMS controller (SMSC) 38 is coupled to system 26 and supports SMS communications among the mobile devices 10/12 and other devices which may be coupled to the internet protocol (IP) network 40. The mobile devices 10/12 may also support other communication services such as MMS, email, a browser for internet access, and/or other data applications. A variety of services, functions and apparatus may be connected to the network 40. For example, servers or other appropriate nodes may provide email service 42 and voice mail service 44 for the mobile devices. A multimedia message service center (MMSC) 46 may provide support for multimedia communications, e.g. pictures or video information. A content provider server 48 is merely illustrative of the many possible sources of information which are available over the Internet. An SMS server 50 provides an interface between communications utilizing the SMS protocol and other communication protocols such as packets transmitted over the Internet.

FIG. 2 is a block diagram of an illustrative embodiment of a mobile device, e.g. mobile device 10. The functionality of the mobile device is provided by microprocessor 60 which is supported by read-only memory (ROM) 62, random access memory (RAM) 64, and nonvolatile memory 66 such as flash memory, EEPROM, etc. Input/output (I/O) devices 68 may include input devices such as a keypad, keyboard, touchpad, and other buttons such as for cursor movement, screen selection, etc., microphone, and an input port jack for wire-based communications with other devices. The output devices include a display screen 14 and a speaker. A separate microprocessor (not shown) can be dedicated to rendering the video display if the computational load for creating images is too high for the primary microprocessor 60 to handle in addition to the other demands. An input/output communication module 70 supports two-way communications between the microprocessor 60 and external devices such as connected by a cable to the input port jack, by infrared (IR) beam, or by Bluetooth technology. A transmit and receive module 72 coupled to antenna 74 provides radio frequency (RF) communication support with base stations and/or other wireless devices such as by Wi-Fi. The microprocessor 60 operates under the control of an operating system (OS) 80 which provides basic operational functionality, e.g. Symbian, Windows Mobile, Palm, RIM, iPhone, etc. The OS supports application programs 82 that provide higher-level functionality, files 83 that may contain various user information, and privacy interface (PI) application 81.

The PI application 81 functions as “middleware”, i.e. software that provides an interface between the OS, e.g. user inputs, and the higher level applications 82 and files 83. As explained below, the PI application 81 enables the user to create a first group of certain selected applications 82 and files 83 that can be accessed only after the entry of a predetermined password (privacy protected) while permitting applications and files not within the first group to be accessed without the need for the entry of the password (public or not privacy protected). The same valid password operates to protect all of the applications/files that are privacy protected. The PI function also includes encryption functionality that is integrated with the text messaging capability of the SMS mobile device as will be explained in more detail below. The microprocessor in combination with associated memory and other peripheral devices form a microprocessing unit. The PI function can also be incorporated within the OS. Middleware as defined herein refers to its supported functions whether disposed intermediate to the applications and the OS, or incorporated within the OS itself.

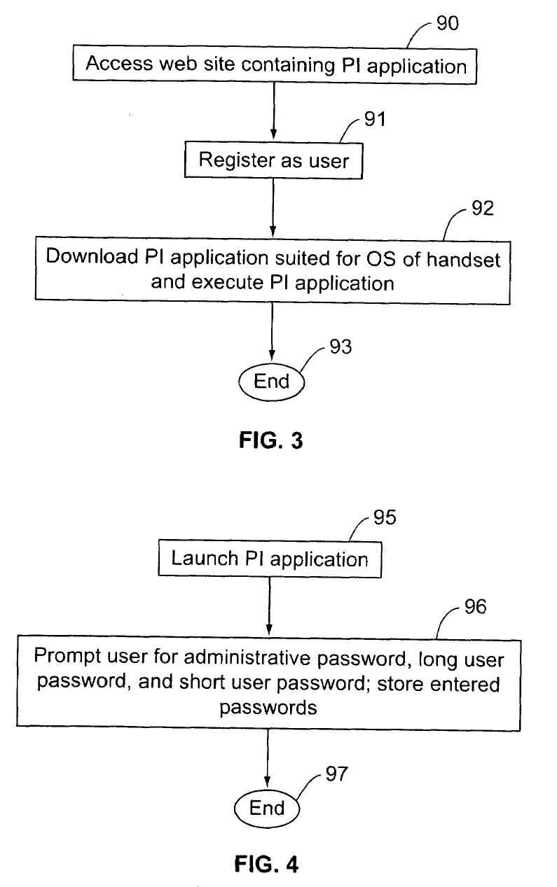

FIG. 3 shows exemplary steps for an initial registration and acquisition of the privacy interface program. In step 90 a user preferably uses his mobile device to access a web site containing the privacy interface application. In step 91 the user is requested by the web site for registration information, e.g. name, address, email address, etc. and completes the registration process by providing the requested information. If a payment is required in order to download the privacy interface application, the user can be given the option to provide payment such as by use of a credit card. In step 92, after having successfully completed the registration process, the privacy interface application suited for use with the operating system of the user's mobile device is downloaded to the mobile device which then executes the downloaded program causing it to be installed as middleware 81 as shown in FIG. 2. The user may be queried as to the manufacturer and model of his mobile device during the registration process in order to identify the appropriate privacy interface application compatible with the particular operating system of his mobile device. Alternatively, the identification of the OS and its version could be retrieved direct from the user's handset, i.e. without manual entry by the user, by a query from the web site if such information is stored and made available by the handset. This process terminates at END 93.

FIG. 4 shows illustrative steps of an exemplary method in which the installed privacy interface program is configured with passwords. In step 95 the user launches the privacy interface application such as by clicking on an associated icon displayed on the screen of his mobile device. Because this is the first execution of the privacy interface application on the user's mobile device, an initial configuration of passwords to be selected by the user is needed. In step 96 the privacy interface application prompts the user to enter an administrative password, a long user password, and a short user password. These passwords are stored in nonvolatile memory for use in association with the provided privacy feature. The administrative password is required in order to be given access to later change the long and short passwords. The long password consists of a series of alphanumeric characters selected by the user, and preferably consists of 6 or more characters, e.g. 6-12 characters. The short password consists of a different series of alphanumeric characters selected by the user, and preferably consists of 4 or fewer characters, e.g. 2-3 characters. In accordance with an embodiment of the present invention, the entry of the long password is initially required to gain access to an application or file in the privacy protected group. Once a privacy protected application or file has been opened/accessed, inactivity by the user as determined by a lack of user input within predetermined time intervals, will cause the need to reenter a password upon an attempt by the user to again access the privacy protected open application. Whether the entry of the long or short password is required depends upon the time interval of inactivity.

The privacy interface program also contains an encryption/decryption program for encrypting clear text messages for transmission and decrypting encrypted text messages that are received. The encryption/decryption program includes a graphical user interface that supports a single click selection of whether text messages being or having been composed will be transmitted as a clear text message or an encrypted message. This process terminates at END 97.

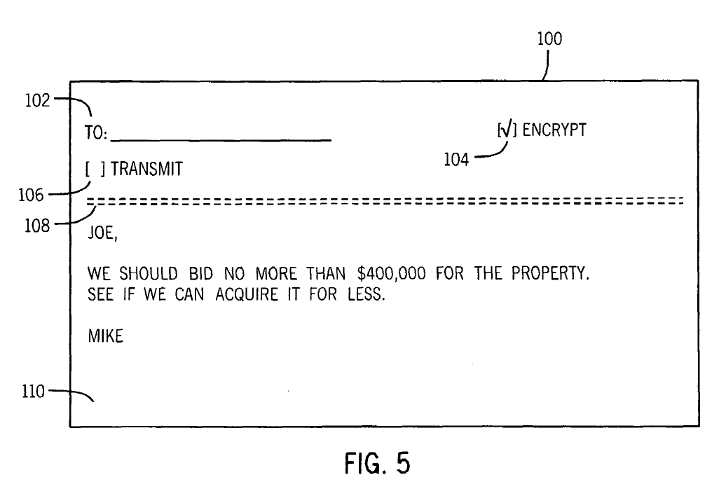

FIG. 5 shows an exemplary secure text messaging window 100 utilized for composition of a text message on an SMS wireless mobile device in accord with a resident messaging application installed by the privacy interface 81. The window includes an addressee or “To:” field 102 into which will be inserted an address, e.g. commonly a telephone number, of the party to receive the subject text message. An encrypt field 104 includes a checkbox icon which, if selected by the user, designates the subject message to be transmitted as an encrypted text message. In the illustrated example, there is a check in the checkbox icon indicating the user has selected to transmit an encrypted message. A transmit field 106 includes a user selectable button icon, which when selected by the user, causes the subject text message to be processed and transmitted. It will be apparent that the transmit button will normally be selected by the user only after the text message has been composed and is ready to be transmitted. The dashed line 108 separates the above header and command information from the body 110 of the text message. Typically the body of the text message will be manually entered by the user using the keys associated with the mobile device or other associated user interface. Depending upon the particular mobile device, it may be possible for the user to load the body of the text message from a previously stored file. In this illustrated example, the information being communicated is regarded as confidential by the author (user) and hence the user has elected to transmit text message as encrypted as indicated by the check in checkbox of the encrypt field 104. Of course, the destination party must have a device, e.g. another wireless mobile device, upon which the message will be received capable of decrypting the encrypted message. The user may click on the encrypt field 104 at any time prior to initiating transmission of the message and cause the checkbox to toggle between two states, transmit message as encrypted or transmit the message as clear text.

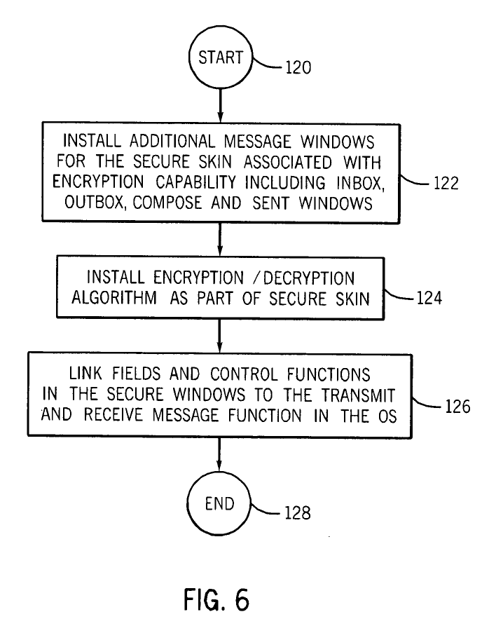

FIG. 6 illustrates an exemplary installation of a secure module that supports encryption/decryption of text messages. These steps are part of the overall installation of the privacy interface application as discussed above with regard to FIG. 4. Beginning at Start 120, the privacy interface application installs a resident application with additional message windows for the secure “skin”, i.e. secure module, associated with the encryption capability in step 122. The additional windows include an inbox, outbox, compose and sent windows. An icon corresponding to each of these windows is also installed as part of the security module. Upon opening the security skin with a corresponding password, the user can select a desired icon causing the associated window to open. In step 124 an encryption/decryption algorithm is installed as part of the security skin. Various types of encryption/decryption algorithms are known and can be utilized depending upon the desired level of security. Bearing in mind that encrypted text will be carried as part of the payload in an SMS packet, it is preferred that the encrypted characters remain in the ASCII character domain in order to simplify transmission of encrypted text messages. In step 126 the fields and control functions associated with the secure windows are linked with the corresponding transmit, receive and message storage functions that are part of the operating system of the mobile device. This completes an interface between the secure windows of the installed application and the mobile device operating system in much the same way that the normal built-in messaging windows are linked. This installation is completed at End 128.

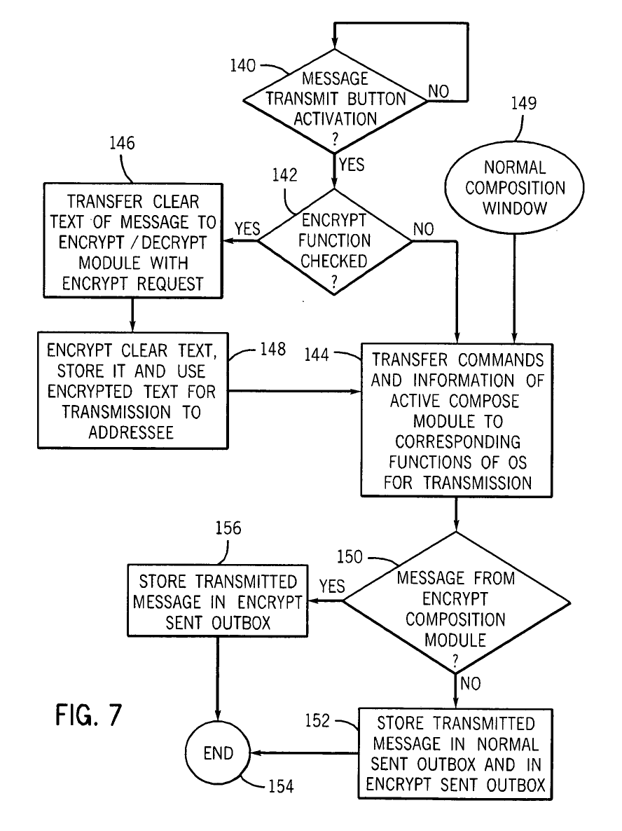

FIG. 7 illustrates the transmission of text messages utilizing the secure text message composition window of the installed application in accordance with an embodiment of the present invention. In step 140 a determination is made of whether the message transmit button has been activated. A NO determination returns to the beginning of the step effectively creating a loop that monitors for the activation on the message transmit button. A YES determination by step 140, indicating a message transmit button activation, proceeds to step 142 in which a determination is made of whether the encrypt text message function 104 has been checked. A NO determination by step 142, indicating that a clear text transmission of the message is to be made, results in processing by step 144 in which the commands and information of the active compose module are transferred to corresponding functions of the operating system for transmission. A YES determination by step 142 results in step 146 transferring the clear text message entered by the user in the secure composition window to the encrypt/decrypt module with a request to perform encryption. In step 148, the encrypt/decrypt module encrypts the clear text message, and stores the corresponding encrypted text message for use as the body of the text message to be transmitted with the subject text message. The process continues with step 144 as previously explained. It will be apparent that the difference made by a YES determination by step 142 is that the body of the text message delivered to step 144 for transmission is the encrypted text version as opposed to the clear text message that would be delivered by a NO determination. It will be noted that step 144 may also receive text messages to be transmitted from the normal composition window 149, i.e. the text messaging composition window that came installed in the mobile device by its manufacturer (a messaging composition window without the capability for encryption and/or decryption).

Following step 144, a determination is made by step 150 of whether the transmitted message came from the encrypt text messaging composition module or from the normal text messaging composition window. A NO determination by step 150 results in the transmitted message being stored in a corresponding normal sent outbox that is part of the text messaging windows installed in the mobile device by its manufacturer and the transmitted message also being stored in the encrypt sent outbox in step 152. Storing the clear text transmitted message also in the encrypt sent outbox provides the user with flexibility in determining whether to later forward this message as encrypted or incorporate it as part of another new message that will be sent as encrypted. This terminates the process at End 154. A YES determination by step 150, indicating that the transmitted text message came from the secure text messaging composition window, results in the text message being stored in the secure sent outbox 156. In order to distinguish messages processed by the secure module, text messages transmitted using the secure text messaging composition window are stored in the outbox of the secure module regardless of whether the encrypt option in the composition window was checked or not checked. Following the storage, the process terminates at End 154.

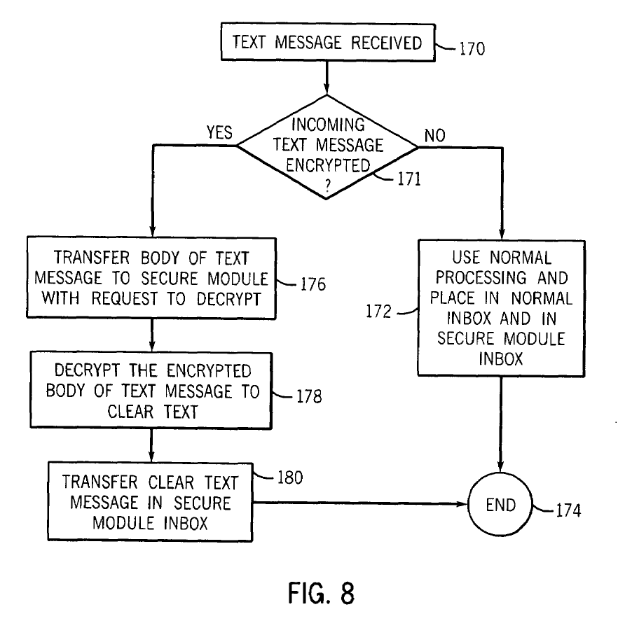

FIG. 8 illustrates the processing of a received text message in accordance with an exemplary embodiment of the present invention. In step 170 a text message from another user is received at a mobile device. A determination is made at step 171 of whether the incoming text message is encrypted. This determination may be made by testing for the presence of a predetermined encryption flag transmitted as part of the header of the SMS messaging packet with the received text message. A NO determination by step 171 results in step 172 using normal processing of the received text message and placing it in the normal inbox, i.e. the text messaging inbox installed by the manufacturer of the mobile device. This normal inbox is not part of the installed secure modules. The clear text received message is duplicated and stored in the secure module inbox to provide the user with flexibility to later forward this message as encrypted or incorporate it as part of another new message that will be sent as encrypted. The process terminates that End 174.

A YES determination by step 171 results in step 176 transferring the body of the received text message to the encryption/decryption module on the secure module with a request to perform a decryption. In step 178 the encrypt/decrypt module decrypts the received encrypted body of the text message to clear text. In one embodiment, the encrypt/decrypt modules as installed on all mobile devices contain the same encryption and decryption methodology so that all mobile devices with installed secure modules as part of the privacy interface application are capable of transmitting encrypted messages to and decrypting received messages from other users with the installed secure module. In step 180 the decrypted clear text message is transferred to the secure module inbox so that the clear text message can be read by the user. This process terminates at End 174.

In accordance with an embodiment of the present invention, the inbox, outbox, composition and sent windows of the secure module (installed resident application) operate as separate additional functions in addition to the text messaging inbox, outbox, composition and sent windows that are normally part of the software as supplied by the manufacturer of the mobile device. Users may utilize the capabilities of both the secure modules and normally provided messaging functions. For example, a user and his business associates may utilize the secure module to transmit and receive encrypted messages with each other. The same user and his social friends may utilize either the secure modules or the normal text messaging functions to transmit and receive clear text messages with each other.

Of course, since the text messaging composition window of the secure module has the ability to select transmission of the text message as an encrypted message or as clear text, this composition window can be utilized to compose all text messages. The ability to select (toggle) whether a text message will be transmitted as an encrypted message or not at any time during the composition of the message provides great flexibility. For example, the user may initially believe that the message being composed will be transmitted as clear text, but may include sensitive information in a latter part of the message being composed. The composition window of the secure module allows the user to transmit the text message as encrypted by merely checking the checkbox of the encrypt field 104 any time prior to the transmission of the message. Similarly, the user may initially believe that sensitive information will be included in the text of a message, but such sensitive information may not actually end up being part of the message. In this case, the user can simply toggle the previously checked encryption checkbox so that the checkbox is now not checked prior to the transmission of the message so that the text message will be transmitted as clear text. Regardless of whether the encryption checkbox is checked or not, the user (originator/author) enters the text message as clear text in the body of the composition window.

It may be convenient to copy a received text message from one party and paste it into the secure composition window so that it can be modified and sent to another party as either clear text or encrypted. For example, a received message may not contain any information considered confidential by the recipient, but the recipient may add information that is considered confidential. The recipient can elect to send or forward the revised message to another party as encrypted text to protect the added confidential information.

The mobile device in one example employs one or more computer-readable signal-bearing tangible media. The computer-readable signal-bearing media store software, firmware and/or assembly language for performing one or more portions of one or more embodiments of the invention. The computer-readable signal-bearing medium for the mobile device in one example comprise one or more of a magnetic, electrical, optical, biological, and atomic data storage tangible medium. For example, the computer-readable signal-bearing medium comprise floppy disks, magnetic tapes, CD-ROMs, DVD-ROMs, hard disk drives, flash drives and electronic memory.

Although exemplary implementations of the invention have been depicted and described in detail herein, it will be apparent to those skilled in the art that various modifications, additions, substitutions, and the like can be made without departing from the spirit of the invention. For example, different visual characteristics, e.g. color, shapes, texture, etc., can be used to distinguish whether text messages are currently designated to be sent as an encrypted text message. Such visual characteristics may be applied to the encrypt checkbox icon, at least a portion of the composition window such as the text body portion, and/or the text characters being composed to alert the user of the current encryption status of a message being composed. Similarly, such visual characteristics can alert a user of the encryption status of a received text message. The displayed clear text of a received encrypted message could have such visual characteristics applied to distinguish the received message as having been received as an encrypted message. For example, the color of the background of the window displaying the decrypted text message (or the color of the text itself) could be a different color from messages received that were not encrypted. Instead of providing a user selectable encryption icon on the screen to control whether a text message will be transmitted as encrypted, a different user input, e.g. a designated button on the keypad, could be used to select and/or toggle the encryption state for the message. Various hardware, software, firmware, and combinations thereof can be used to implement the functionality and characteristics described herein in a mobile device.

The scope of the invention is defined in the following claims.

We claim:

1. A method implemented by a wireless mobile device for transmitting and receiving short message system (SMS) messages, the method comprising the steps of:
storing entered first text to be transmitted as a first SMS text message from the wireless mobile device by a resident application capable of encrypting the first text prior to transmission;
receiving a user selectable input by the resident application of the wireless mobile device where the user selectable input controls whether a resident encryption algorithm of the resident application will be used to convert the first text into an encrypted first text message;
receiving a user control input by the resident application that causes the transmission of the first SMS text message from the wireless mobile device, where the text of the transmitted first SMS text message contains the first text if the resident encryption algorithm has not been selected by the user selectable input upon receiving the user control input, the text of the transmitted first SMS text message containing encrypted first text if the resident encryption algorithm has been selected by the user selectable input upon receiving the user control input.

2. The method of claim 1 wherein the step of receiving a user selectable input comprises the steps of:
displaying an icon on the screen of the mobile device having first and second states corresponding to selecting utilization of the resident encryption algorithm and selecting not to utilize the resident encryption algorithm, respectively;
detecting which of the first and second states is a current state.

3. The method of claim 2 further comprising the step of toggling the current state of the icon from one of the first and second state to the other of the first and second state on each user selectable input.

4. The method of claim 2 wherein the displaying of the icon comprises displaying the icon on a message composition window on the screen of the mobile device.

5. The method of claim 3 wherein the icon comprises a checkbox that is toggled from being checked to being not checked corresponding to the first and second states, respectively.

6. The method of claim 2 further comprising the steps of displaying a one visual characteristic associated with the first text during the first state and another visual characteristic associated with the first text during the second state, where the one and another visual characteristics provides a discernable indication to the user of which of the first and second states is the current state.

7. A tangible signal-bearing media readable by a wireless mobile device that causes the wireless mobile device to store entered first text to be transmitted as a first short message system (SMS) text message, the media comprising:
means in the media for encrypting the first text prior to its transmission;
means in the media for causing the wireless mobile device to receive a user selectable input where the user selectable input controls whether the first text is encrypted into an encrypted text message;
means in the media for causing the wireless mobile device to receive a user control input that causes the transmission of the first SMS text message from the wireless mobile device, where the text of the transmitted first SMS text message contains the first text if encryption has not been selected by the user selectable control input, the text of the transmitted first SMS text message containing encrypted first text if encryption has been selected by the user control input.

8. The media of claim 7 wherein the means for receiving a user selectable input comprises:
means for displaying an icon on the screen of the mobile device having first and second states corresponding to selecting utilization of the resident encryption algorithm and selecting not to utilize the resident encryption algorithm, respectively;
means for detecting which of the first and second states is a current state.

9. The media of claim 8 further comprising means in the media for toggling the current state of the icon from one of the first and second state to the other of the first and second state on each user selectable input.

10. The media of claim 8 wherein the means in the media for displaying of the icon comprises means in the media for displaying the icon on a message composition window on the screen of the mobile device.

11. The media of claim 9 wherein the icon is a checkbox that is toggled from being checked to being not checked corresponding to the first and second states, respectively.

12. The media of claim 8 further comprising means in the media for displaying a one visual characteristic associated with the first text during the first state and another visual characteristic associated with the first text during the second state, where the one and another visual characteristics provides a discernable indication to the user of which of the first and second states is the current state.

13. A wireless mobile device that transmits and receives short message system (SMS) text messages comprising:
memory that stores entered first text to be transmitted as a first SMS text message from the wireless mobile device;
microprocessing unit for encrypting the first text under the control of a resident application;
the microprocessing unit receiving a user selectable input via the resident application of the wireless mobile device where the user selectable input controls whether encryption will be used to convert the first text into an encrypted first text message;
the microprocessing unit receiving a user control input via the resident application that causes the transmission of the first SMS text message from the wireless mobile device, where the text of the transmitted first SMS text message contains the first text if encryption has not been selected by the user selectable input upon receiving the user control input, the text of the transmitted first SMS text message containing encrypted first text if the encryption has been selected by the user selectable input upon receiving the user control input.

14. The wireless mobile device of claim 13 wherein the microprocessing unit receiving a user selectable input comprises:
the microprocessing unit displaying an icon on the screen of the mobile device having first and second states corresponding to selecting utilization of encryption and selecting not to utilize encryption, respectively;
the microprocessing unit detecting which of the first and second states is a current state.

15. The wireless mobile device of claim 14 further comprising the microprocessing unit toggling the current state of the icon from one of the first and second state to the other of the first and second state on each user selectable input.

16. The wireless mobile device of claim 14 wherein the displaying of the icon comprises the microprocessing unit displaying the icon on a message composition window on the screen of the mobile device.

17. The wireless mobile device of claim 15 wherein the icon comprises a checkbox that is toggled from being checked to being not checked corresponding to the first and second states, respectively.

18. The wireless mobile device of claim 14 further comprising the microprocessing unit displaying a one visual characteristic associated with the first text during the first state and another visual characteristic associated with the first text during the second state, where the one and another visual characteristics provides a discernable indication to the user of which of the first and second states is the current state.
